(19) United States
(12) Patent Application Publication
(10) Pub. No.: US 2022/0001823 A1
(43) Pub. Date: Jan. 6, 2022

(54) METHOD FOR OPERATING A RESTRAINT SYSTEM, AND RESTRAINT SYSTEM FOR A VEHICLE

(71) Applicant: AUDI AG, Ingolstadt (DE)

(72) Inventors: Franz FÜRST, Buxheim (DE); Christoph GRUNDHEBER, Gaimersheim (DE); Walter KRÖNES, Gaimersheim (DE); Bernd JAKOBS, Nürnberg (DE)

(73) Assignee: AUDI AG, Ingolstadt (DE)

(21) Appl. No.: 17/294,034

(22) PCT Filed: Dec. 3, 2019
(86) PCT No.: PCT/EP2019/083467

§ 371 Date: May 14, 2021

(30) Foreign Application Priority Data
Jan. 23, 2019 (DE) 10 2019 200 813.5

(51) Int. Cl. B60R 21/015

(52) U.S. Cl. CPC B60R 21/01552; B60R 2021/01225

(57) ABSTRACT

The present disclosure relates to a method for operating a restraint system having at least one airbag, wherein a head position of a vehicle occupant relative to a reference point in the vehicle is continuously defined. The distance between the head of the vehicle occupant and the at least one airbag in the idle state is determined from the defined head position of the vehicle occupant. The determined distance is evaluated by a comparison with stored reference values and at least one triggering size of the at least one airbag is determined on the basis of the comparison. When the restraint system is triggered, triggering signals corresponding to the at least one triggering size are transmitted to the at least one airbag, as well as to a corresponding restraint system for a vehicle.

### TECHNICAL FIELD

The present disclosure relates to a method for operating a restraint system as exemplified by the claims. The present disclosure also relates to a restraint system for a vehicle.

### BACKGROUND

Methods for operating restraint systems and restraint systems for vehicles are known in numerous variations. To ensure that occupants in the first row of seats are well protected by seatbelts and airbags in the event of an accident, instructions for correct seat adjustment are provided in the logbook. These instructions relate, among other things, to a seat distance to be selected from the steering wheel or the instrument panel and the correct setting of the backrest. The occupants of the first row of seats (driver and front passenger) currently are not allowed to take a comfortable seat position during the trip, which is characterized either by a greater distance from the steering wheel or the instrument panel and/or by a greater inclination of the backrest. This means that neither the driver nor the front passenger can take a so-called “comfort position” or “rest position,” as is known from trains or airplanes, for example. In future vehicles with automated driving functions, however, one would also like to offer the occupants of the first row of seats “comfort positions” or “rest positions” during a partially automated or fully automated trip.

DE 10 2013 001 482 A1 discloses a method for actuating an airbag arranged in a vehicle having a switchable vent. In this case, an airbag size is set continuously or in at least two stages and/or an airbag shape and the switchable ventilation depending on detected occupant load-relevant parameters.

DE 198 26 662 A1 discloses a generic method and a generic device for controlling the inflation behavior of an airbag, in particular a front airbag of a motor vehicle. In this case, the airbag is inflated depending on the distance between the airbag and the head or upper body of the occupant, wherein the distance between the airbag and the head or the upper body of the occupant is determined from the adjustment position of at least one adjustment part of a seat with respect to the position of the airbag and the distance between the head or the upper body with respect to one of the adjustment parts into which the distance sensor is integrated. The inflation behavior can include the inflation volume and/or the inflation speed and/or the start of inflation of the airbag. The distance sensor can for example be arranged in the headrest or in the shoulder region of the backrest and control the height of the headrest, the height of a height-adjustable backrest and/or the seat occupancy detection. To determine the distance, for example, the positions of the longitudinal seat adjustment, the seat cushion height adjustment, the backrest adjustment, and the steering wheel depth and steering wheel inclination adjustment can be used. If the distance between the occupant and the airbag falls below a first predetermined minimum distance which, even if the airbag is triggered to a reduced extent, harbors a considerable risk of injury to the occupant by the airbag, the airbag will not be triggered. If the distance between the occupant and the airbag is above the first predetermined minimum distance and below a defined second minimum distance, then the airbag inflates to a reduced extent. In this distance range, there is still a risk of injury to the occupant from the airbag if it were completely inflated with all available energy. If the distance between the airbag and the occupant is above the defined second minimum distance and below a predetermined third minimum distance, it results in a complete inflation of the airbag. If the distance between the occupant and the airbag exceeds the defined third minimum distance, then the airbag is inflated completely, but with a time delay, in order to com-pensate for an adjustment to the distance between the occupant and the airbag, which distance is too great.

### BRIEF DESCRIPTION OF THE DRAWINGS/FIGURES

FIG. 1 is a schematic block diagram of a vehicle with an embodiment of a restraint system according to the present disclosure for a vehicle;

FIG. 2 is a schematic representation of a section of an interior of the vehicle from FIG. 1 having an occupant and a seat in a normal position and an airbag triggered with a first deployment depth;

FIG. 3 is a schematic representation of the section of the interior of the vehicle from FIG. 2 with the occupant and the seat in a comfort position and the airbag triggered at a second deployment depth; and

FIG. 4 is a schematic flow diagram of an embodiment of a method according to the present disclosure for operating a restraint system.

### DETAILED DESCRIPTION

The present disclosure is based on the object of providing a method for operating a restraint system and a restraint system for a vehicle which provide an appropriate level of occupant protection for different seat positions.

This object is achieved by a method for operating a restraint system and by a restraint system for a vehicle as exemplified by the claims. The claims also specify the advan-tageous configurations with further developments of the present disclosure.

In order to provide a method for operating a restraint system which provides an appropriate level of occupant protection for different seat positions, a head position of a vehicle occupant relative to a reference point in the vehicle is continuously defined, wherein a distance between the head of the vehicle occupant and the at least one airbag in the idle state is determined from the defined head position of the vehicle occupant, and the distance determined is evaluated by a comparison with stored reference values and at least one triggering size of the at least one airbag is determined on the basis of the comparison, wherein, when the restraint system is triggered, triggering signals corresponding to the at least one triggering size are transmitted to the at least one airbag. According to the present disclosure, at least one airbag for bridging the distance between the head of the vehicle occupant and the at least one airbag has different deployment depths. In this case, a first triggering size is defined, which activates the at least one airbag with a first deployment depth when the distance determined is below a first threshold value or corresponds to the first threshold value, wherein a second triggering size is defined, which activates the at least one airbag with a second, larger deployment depth when the distance determined is above the first threshold value, and wherein a warning signal which indicates an unsafe seat position is output to the occupant when the distance determined is above a second threshold value which is greater than the first threshold value.

In addition, a restraint system for a vehicle, having at least one airbag, at least one evaluation and control unit and at least one sensor system is proposed, wherein the at least one sensor system continuously defines a head position of a vehicle occupant relative to a reference point in the vehicle and transmits it to the evaluation and control unit, which determines a distance between the head of the vehicle occupant and the at least one airbag in the idle state from the determined head position of the vehicle occupant, and the distance determined is evaluated by a comparison with reference values stored in a storage device, wherein the evaluation and control unit determines at least one triggering size of the at least one airbag on the basis of the comparison, wherein, when the restraint system is triggered, the evaluation and control unit transmits triggering signals corresponding to the at least one triggering size to the at least one airbag. According to the present disclosure, at least one airbag has different deployment depths for bridging a distance between the head of the vehicle occupant and the at least one airbag, wherein the evaluation and control unit defines a first triggering size, which activates the at least one airbag with a first deployment depth when the distance determined is below a first threshold value or corresponds to the first threshold value, wherein the evaluation and control unit defines a second triggering size, which activates the at least one airbag with a second, larger deployment depth when the distance determined is above the first threshold value, and wherein the evaluation and control unit outputs a warning signal which indicates an unsafe seat position of the occupant via an output unit to the occupant when the distance determined is above a second threshold value which is greater than the first threshold value.

Thus, for actuating the adaptivity of the deployment depth in at least one airbag with the aid of the reference variable “head distance,” a control criterion for this adaptivity of the deployment depth is formed. For this purpose, corresponding categories for actuating the at least one airbag are formed depending on various threshold values. The at least one airbag is preferably a front airbag, such as a driver airbag or a front passenger airbag. In the case of the driver's airbag with different deployment depths, a distance between the head and a reference point in the region of the impact absorber or steering wheel, in which the driver's airbag is arranged in the rest position, is determined. In the case of the front passenger airbag with different deployment depths, a distance between the head and a reference point in the region of the instrument panel in which the front passenger airbag is arranged in the rest position is determined.

Embodiments of the present disclosure allow occupants of the first row of seats, such as a driver and/or front passenger, to assume a comfortable seat position during a partially automated or fully automated trip and, in the event of an accident, experience a level of protection from the corresponding airbag comparable to an upright seat position.

In some aspects of the method, an inflation speed of the at least one airbag can be set depending on the distance determined. In this case, the at least one airbag can be inflated at a first speed if the distance determined is below a third threshold value or is equal to a third threshold value, which is smaller than the first threshold value. In addition, the at least one airbag can be inflated at a higher second speed if the distance determined is above the third threshold value.

In some aspects of the method, a damping behavior of the at least one airbag can be set depending on the distance determined. In this case, at least one triggering size for setting the damping behavior can be defined on the basis of the comparison of the distance determined with stored reference values and a corresponding triggering signal can be output to the at least one airbag. As a result, the damping behavior of the at least one airbag can also be adjusted to different positions of the occupant.

In some aspects of the method, before or when the restraint system is triggered, a position of a seat can be changed so that the distance between the head of the vehicle occupant and the at least one airbag is in the range of the defined threshold values. For example, the corresponding seat can be moved in the direction of the steering wheel or in the direction of the instrument panel if the distance determined is greater than the third threshold value.

In some aspects of the method, the head position of a vehicle occupant can be defined directly by means of a distance sensor system. The distance sensor system can include, for example, an ultrasound system and/or an infrared system and/or a camera system, which can directly determine the head position of a vehicle occupant relative to a reference point in the vehicle. Additionally or alternatively, the head position of a vehicle occupant can be defined indirectly by means of a seat position sensor system. The seat position sensor system can include, for example, a seat cushion sensor which detects a set height and a longitudinal position of the seat cushion of the corresponding seat, a backrest sensor which detects a set inclination of the backrest, and a headrest sensor which detects a set position of the headrest. In the case of a multi-part backrest, an upper region of the backrest, which is also referred to as the backrest head, can be adjusted relative to a lower region of the backrest using at least one corresponding adjustment element. In addition, at least one further sensor can detect a set position of the upper region of the backrest or the backrest head relative to a lower region of the backrest. With such a seat position sensor system, the head position of the vehicle occupant can be estimated well, so that a probable distance range in which the head of the vehicle occupant is located can be defined. It is thus possible to determine whether the occupant's head is located in a first distance range, which is limited upwards by the first threshold value, or in a second distance range, which is limited downwards by the first threshold value and upwards by the second threshold value, or in a third distance range, which is limited downwards by the second threshold value and upwards by the third threshold value, or in a fourth distance range, which is limited downwards by the third threshold value. The exact head position of the occupant determined by means of the distance sensor system can then be used to specify the inflation behavior and/or the damping behavior of the corresponding airbag for the determined exact head position of the vehicle occupant. For example, the inflation volume and/or the inflation speed and/or the start of the inflation and/or the damping of the airbag can be adjusted to the determined exact head position of the vehicle occupant.

In some aspects of the method, when determining the distance between the head of the vehicle occupant and the at least one airbag in the idle state, a steering wheel position can be taken into consideration. Since the position of the corresponding airbag in the idle state is changed by changing the steering wheel position, the steering wheel position has an influence on the distance between the head of the vehicle occupant and the airbag in the idle state. The steering wheel position is therefore advantageously taken into consideration when determining the distance, in particular when the head position is determined indirectly via the seat position sensor system.

In some aspects of the method, the restraint system can comprise a belt tensioner and/or an adaptive belt force limiter, in which different force levels can be set. In this case, at least one triggering size of the belt tensioner and/or the adaptive belt force limiter can be defined on the basis of the comparison between the distance determined and stored reference values, and corresponding triggering signals can be transmitted to the belt tensioner and/or to the adaptive belt force limiter. As a result, the functions of the belt tensioner and/or the belt force limiter can also be adjusted to different positions of the occupant.

In some aspects of the restraint system, at least one airbag generator can be provided, the evaluation and control unit actuating the airbag generator in order to set an inflation speed of the at least one airbag depending on the distance determined. The airbag generator can inflate the at least one airbag at a first speed if the distance determined is below a third threshold value or is equal to the third threshold value, which is smaller than the first threshold value. The airbag generator can inflate the at least one airbag at a higher second speed if the distance determined is above the third threshold value.

In some aspects of the restraint system, the at least one airbag can comprise at least one tightening strap which limits deployment of the at least one airbag to the first deployment depth. In this case, the evaluation and control unit can release the at least one tightening strap via a release element (not shown) in order to activate the at least one airbag with the second greater deployment depth. The at least one tightening strap makes it possible to specify a desired deployment depth in a simple manner when the airbag is activated.

In some aspects of the restraint system, the at least one airbag can comprise at least one valve. In this case, the evaluation and control unit can define at least one triggering size of the at least one valve on the basis of the comparison of the distance determined with stored reference values and output a corresponding triggering signal to the at least one valve to adjust the damping behavior of the at least one airbag. The at least one valve makes it possible in a simple manner to specify a desired damping behavior when activating the airbag.

In some aspects of the restraint system, before or when the restraint system is triggered, the evaluation and control unit can change a position of a seat via at least one adjusting element in such a way that the distance between the head of the vehicle occupant and the at least one airbag is in the range of the defined threshold values. The at least one adjustment element can be used to change, for example, a position of the seat cushion in the vertical direction of the vehicle and/or in the longitudinal direction of the vehicle or an angle of inclination of the vehicle backrest or a position of a headrest or a position of a backrest head. The at least one adjusting element can comprise, for example, an electrical or hydraulic or pneumatic actuator.

The advantages described for the method according to the present disclosure for operating a restraint system also apply to the restraint system according to the present disclosure for a vehicle and vice versa.

The features and feature combinations mentioned above in the description, as well as the features and feature combinations mentioned below in the description of the figures and/or shown only in the figures, can be used not only in the respectively specified combina-tion but also in other combinations or in isolation without getting out of the scope of the present disclosure. Embodiments of the present disclosure, which are not explicitly shown or explained in the figures but derive therefrom and can be produced by separated combinations of features from the embodiments explained, are thus to be regarded as included and disclosed.

Embodiments of the present disclosure are shown in the drawing and are explained in more detail in the following description. In the drawing, the same reference signs designate components or elements that perform the same or analogous functions.

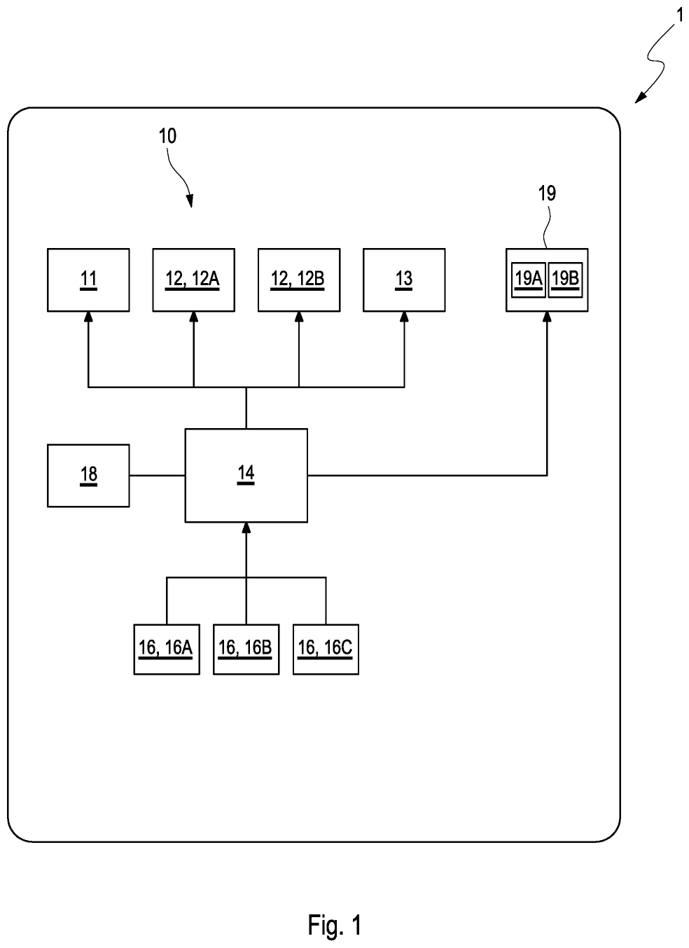

As can be seen from FIGS. 1 to 3, the restraint system 10 for a vehicle 1 has at least one airbag 12, at least one evaluation and control unit 14, and at least one sensor system 16. The at least one sensor system 16 continuously defines a head position of a vehicle occupant 3 to a reference point in the vehicle 1 and transmits the head position of the vehicle occupant 3 to the evaluation and control unit 14, which determines a distance A between the head 5 of the vehicle occupant 3 and the at least one airbag 12 in the idle state from the determined head position of the vehicle occupant 3 and evaluates the distance A determined by a comparison with reference values stored in a storage device 18. The evaluation and control unit 14 defines at least one triggering size of the at least one airbag 12 on the basis of the comparison and, when the restraint system 10 is triggered, transmits triggering signals corresponding to the at least one triggering size to the at least one airbag 12.

According to the present disclosure, at least one airbag 12A for bridging the distance A between the head 5 of the vehicle occupant 3 and the at least one airbag 12A has different deployment depths ET1, ET2. In this case, the evaluation and control unit 14 defines a first triggering size which activates the at least one airbag 12A with a first deployment depth ET1 when the distance A determined is below a first threshold value or corresponds to the first threshold value. The evaluation and control unit 14 defines a second triggering size which activates the at least one airbag 12A with a second greater deployment depth ET2 when the distance A determined is above the first threshold value. In addition, the evaluation and control unit 14 outputs a warning signal to the occupant 3 via an output unit 19, which indicates an unsafe seat position of the occupant 3 if the distance A determined is above a second threshold value which is greater than the first threshold value.

If the distance A determined is above the second threshold value, then the occupant 3 is too far away from the airbag 12A to be deployed, so that its second deployment depth ET2 is also insufficient to accommodate the occupant in the event of a crash. The occupant 3 is therefore informed or warned in good time before the airbag 12A is triggered by outputting the warning signal if he has assumed an unsafe seat position.

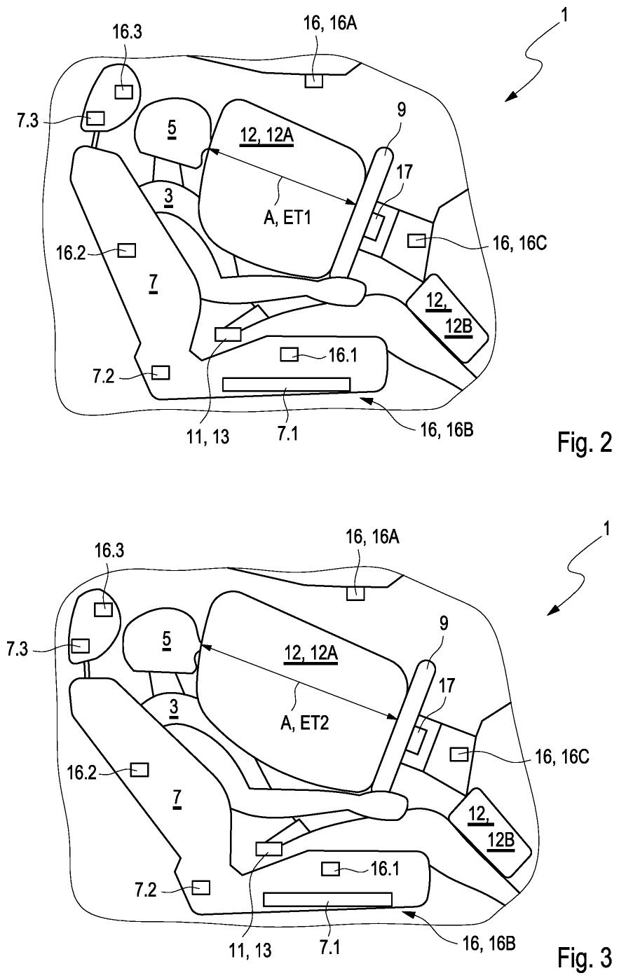

In FIGS. 2 and 3, the airbag 12A is shown as a driver airbag with different deployment depths ET1, ET2. Of course, the front passenger airbag (not shown) is also designed as an airbag 12A with different deployment depths ET1, ET2. In addition, the restraint system 10 also comprises two airbags 12 designed as knee airbags 12B, which have only one deployment depth. In this case, too, only the knee airbag 12B for the driver is shown. The front passenger knee airbag 12B is not shown. Furthermore, the restraint system 10 can also include further airbags 12, such as head airbags, window airbags, roof airbags, etc.

In order to implement the different deployment depths ET1, ET2, the illustrated airbag 12A comprises at least one tightening strap which limits deployment of the at least one airbag 12A to the first deployment depth ET1. In this case, the evaluation and control unit 14 can release the at least one tightening strap via a corresponding triggering signal and a release element (not shown) in order to activate the at least one airbag 12A with the second greater deployment depth ET2.

In addition, in the embodiment shown, the restraint system 10 comprises an airbag generator 17 for the at least one airbag 12A. In this case, the evaluation and control unit 14 controls the airbag generator 17 so as to set an inflation speed of the at least one airbag 12A depending on the distance A determined. If the distance A determined is below a third threshold value or is equal to the third threshold value, which is smaller than the first threshold value, the evaluation and control unit 14 controls the airbag generator 17 so that the airbag generator 17 inflates the at least one airbag 12A with a first speed. If the distance A determined is above the third threshold value, the evaluation and control unit 14 controls the airbag generator 17 in such a way that the airbag generator 17 inflates the at least one airbag 12A at a higher second speed.

In addition, the at least one airbag 12A comprises at least one valve (not shown in detail), in order to adjust the damping behavior of the at least one airbag 12A. In this case, the evaluation and control unit 14 can define at least one triggering size of the at least one valve on the basis of the comparison of the distance A determined with stored reference values and output corresponding triggering signals to the at least one valve to adjust the damping behavior of the at least one airbag 12A.

As can also be seen from FIGS. 1 to 3, the at least one sensor system 16 in the illustrated embodiment comprises a distance sensor system 16A which is arranged in the roof region and which directly defines the head position of a vehicle occupant 3. In the embodiment shown, the distance sensor system 16A is designed as a camera system. Alternatively, the distance sensor system 16A can also use other suitable systems, such as, for example, an ultrasound system or an infrared system, in order to determine the head position of a vehicle occupant 3 directly. In addition, the at least one sensor system 16 in the illustrated embodiment comprises a seat position sensor system 16B which indirectly defines the head position of a vehicle occupant 3. In the embodiment shown, the seat position sensor system 16B comprises a seat cushion sensor 16.1, which detects a set height and a longitudinal position of the seat cushion of the corresponding seat 7, a backrest sensor 16.2, which detects a set inclination of the backrest of the seat 7, and a headrest sensor 16.3, which detects a set position of the headrest of the seat 7. In an embodiment (not shown) of the restraint system 10 according to the present disclosure, the backrest is designed in multiple parts. In the case of a multi-part backrest of this type, an upper region of the backrest, which is also referred to as the backrest head, can be adjusted relative to a lower region of the backrest using at least one corresponding adjustment element. In addition, at least one further sensor can detect a set position of the upper region of the backrest or the backrest head relative to a lower region of the backrest.

Furthermore, in the embodiment shown, the at least one sensor system 16 comprises a steering wheel sensor system 16C which determines a current steering wheel position. The evaluation and control unit 14 takes the steering wheel position into consideration when determining the distance A between the head 5 of a vehicle occupant 3 and the airbag 12A in the idle state.

As can also be seen from FIGS. 1 to 3, the restraint system 10 comprises a belt tensioner 11. In this case, the evaluation and control unit 14 defines at least one triggering size of the seat belt tensioner 11 on the basis of the comparison of the distance A determined with stored reference values and transmits corresponding triggering signals to the seat belt tensioner 11. In addition, in the embodiment shown, the restraint system 10 comprises an adaptive belt force limiter 13, in which different force levels can be set, the evaluation and control unit 14 defining at least one triggering size of the adaptive belt force limiter 13 on the basis of the comparison of the distance A determined with stored reference values and transmitting corresponding triggering signals to the adaptive belt force limiter 13. As a result, the functions of the seat belt tensioner 11 and the adaptive belt force limiter 13 in the illustrated embodiment can be adjusted to a position of the occupant 3, the evaluation and control unit 14 determining or estimating the position of the occupant 3 based on the defined head position of the occupant 3.

In the embodiment shown, the seat 7 is designed as an “active” seat 7. This means that the seat 7 has a seat length and seat height adjustment 7.1, a backrest adjustment 7.2 and a headrest adjustment 7.3, via which the position and location of the seat 7 can be set via corresponding adjustment elements. The adjusting element can for example comprise an electric or hydraulic or pneumatic actuator. In the embodiment shown, the evaluation and control unit 14 can change a position of the active seat 7 via the adjustment elements before or when the restraint system 10 is triggered so that the distance A between the head 5 of the vehicle occupant 3 and the airbag 12A is in the range of the defined threshold values. In the illustrated embodiment, the evaluation and control unit 14 controls the seat length and seat height adjustment 7.1, the backrest adjustment 7.2, and the headrest adjustment 7.3 so that the corresponding seat 7 is moved in the direction of the steering wheel 9 or in the direction of the instrument panel when the distance A determined is greater than the second threshold value. At the same time, the backrest is raised and the headrest is placed on the head 5 of the occupant 3. In an embodiment (not shown) of the restraint system 10 according to the present disclosure, the backrest is designed in multiple parts. With such a multi-part backrest, the evaluation and control unit 14 can also adjust the upper region of the backrest or the backrest head via at least one corresponding adjustment element relative to a lower region of the backrest and move it in the direction of the head 5 of the occupant if the distance A determined is greater than the second threshold value.

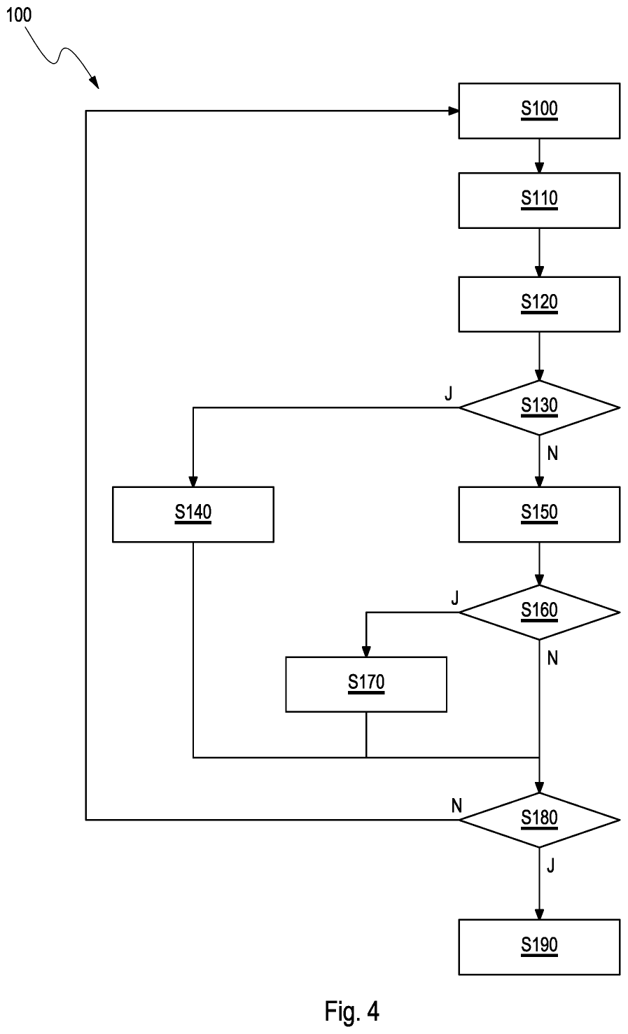

As can also be seen from FIG. 4, in the method 100 for operating a restraint system 10 with at least one airbag 12, a head position of a vehicle occupant 3 is continuously defined in relation to a reference point in the vehicle 1 in a step S100. In a step S110, a distance A between the head 5 of the vehicle occupant 3 and the at least one airbag 12 in the idle state is determined from the defined head position of the vehicle occupant 3. In step S120, the distance A determined is evaluated by a comparison with stored reference values, and at least one triggering size of the at least one airbag 12 is defined on the basis of the comparison.

According to the present disclosure, at least one airbag 12A for bridging the distance A between the head 5 of the vehicle occupant 3 and the at least one airbag 12A has different deployment depths ET1, ET2. In this case, it is checked in step S130 whether the distance A determined is below a first threshold value or is equal to the first threshold value. If the distance A determined is below the first threshold value or if the distance A determined corresponds to the first threshold value, then in step S140 a first triggering size is defined which activates the at least one airbag 12A with a first deployment depth ET1. The method 100 is then continued with a step S180, in which it is checked whether the restraint system 10 is triggered. If the distance A determined is above the first threshold value, then, in step S150, a second triggering size is defined which activates the at least one airbag 12A with a greater second deployment depth ET2. In step S160, it is then checked whether the distance A determined is above a second threshold value, which is greater than the first threshold value. If the distance A determined is not above the second threshold value, then the method 100 continues with step S180, in which it is checked whether the restraint system 10 has been triggered. If the distance A determined is above the second threshold value, then in step S170, a warning signal is output to the occupant 3, which indicates an unsafe seat position. The method 100 is then continued with step S180, in which it is checked whether the restraint system 10 is triggered. If the check in step S180 shows that the restraint system 10 is not triggered, then the method 100 is repeated beginning with step S100. If the check in step S180 shows that the restraint system 10 has been triggered, the at least one airbag 12A is activated with the defined triggering size in step S190.

In addition, an inflation speed of the at least one airbag 12A is set depending on the distance A determined. As already stated above, the at least one airbag 1 is inflated at a first speed if the distance A determined is below a third threshold value or equal to the third threshold value, which is smaller than the first threshold value. In addition, the at least one airbag 12A is inflated at a higher second speed if the distance determined is above the third threshold value.

Furthermore, a damping behavior of the at least one airbag 12A is set depending on the distance determined. As already stated above, the at least one triggering size for setting the damping behavior is defined on the basis of the comparison of the distance A determined with stored reference values. In addition, corresponding triggering signals are output to the at least one airbag 12A.

As already stated above, when the restraint system 10 is triggered, a position of the seat 7 is also changed in such a way that the distance A between the head 5 of the vehicle occupant 3 and the at least one airbag 12A is in the range of the defined threshold values.

In addition, the head position of a vehicle occupant 3 is defined directly by means of a distance sensor system 16A and indirectly by means of a seat position sensor system 16B. In addition, when determining the distance A between the head 5 of the vehicle occupant 3, in this case the driver, and the at least one airbag 12 in the idle state, a steering wheel position is taken into consideration.

Furthermore, in the illustrated embodiment, at least one triggering size of the belt tensioner 11 and the adaptive belt force limiter 13, at which different force levels can be set, is defined on the basis of the comparison of the distance A determined with stored reference values, and corresponding triggering signals are transmitted to the belt tensioner 11 and to the adaptive belt force limiter 13.

Embodiments of the present disclosure allow occupants of the first row of seats (driver and front passenger) to assume a comfortable seat position during the trip. This means that the driver and front passenger can take a so-called “comfort position” or “rest position,” as we know it from trains or airplanes, and can still be protected by the restraint system. In addition, the occupant can be informed or warned in good time before the airbag is triggered if he has assumed an unsafe seat position.

### LIST OF REFERENCE SIGNS

1 Vehicle
3 Occupant
5 Head
7 Seat
7.1 Seat length and seat height adjustment
7.2 Seat back adjustment
7.3 Headrest adjustment
9 Steering wheel
10 Restraint system
11 Seat belt tensioner
12 Airbag
12A Airbag with different deployment depths
12B Knee airbag
13 Belt force limiters
14 Evaluation and control unit
16 Sensor system
16A Distance sensor system
16B Seat position sensor system
16C Steering wheel sensor system
16.1 Seat cushion sensor
16.2 Backrest sensor
16.3 Headrest sensor
17 Airbag generator
18 Storage device
19 Output unit
19A Screen
19B Loudspeaker
A Distance
ET1, ET2 Deployment depth
100 Method for operating a restraint system
S100 to S190 Method step

1-17. (canceled)

18. A method for operating a restraint system having at least one airbag, the method comprising:
determining a distance between a head position of a vehicle occupant and the at least one airbag,
wherein the head position of the vehicle occupant is continuously defined relative to a reference point in a vehicle and the at least one airbag is in an idle state from the head position of the vehicle occupant and has different deployment depths for bridging the distance between the head position of the vehicle occupant and the at least one airbag;
comparing the distance determined with stored reference values;
determining at least one triggering size of the at least one airbag based on the comparison; and
transmitting triggering signals corresponding to the at least one triggering size to the at least one airbag, such that:
a first triggering size activates the at least one airbag with a first deployment depth when the distance determined is below or equal to a first threshold value,
a second triggering size activates the at least one airbag with a second deployment depth when the distance determined is above the first threshold value, wherein the second deployment depth is larger than the first deployment depth, and
a warning signal indicates an unsafe seat position is output to the vehicle occupant when the distance determined is above a second threshold value which is greater than the first threshold value.

19. The method of claim 18, further comprising setting an inflation speed of the at least one airbag depending on the distance determined, such that:
the at least one airbag is inflated at a first speed if the distance determined is below or equal to a third threshold value, the third threshold value is smaller than the first threshold value, and
the at least one airbag is inflated at a second speed if the distance determined is above the third threshold value, wherein the second speed is higher than the first speed.

20. The method of claim 18, further comprising setting a damping behavior of the at least one airbag depending on the distance determined.

21. The method of claim 18, further comprising changing, before or when the restraint system is triggered, a position of a seat in such a way that the distance between the head position of the vehicle occupant and the at least one airbag is in a range of the defined threshold values.

22. The method of claim 18, wherein the head position of the vehicle occupant is defined directly by a distance sensor system.

23. The method of claim 18, wherein the head position of the vehicle occupant is defined indirectly by a seat position sensor system.

24. The method of claim 18, wherein the determining a distance includes considering a steering wheel position.

25. The method of claim 18, further comprising:
defining at least one triggering size of a belt tensioner or an adaptive belt force limiter based on the comparison of the distance determined with the stored reference values; and
transmitting corresponding triggering signals to the belt tensioner or the adaptive belt force limiter.

26. A restraint system for a vehicle, the restraint system comprising:
at least one airbag that has different deployment depths for bridging a distance between a head position of a vehicle occupant and the at least one airbag;
an evaluation and control unit configured to:
determine the distance between the head position of the vehicle occupant and the at least one airbag in an idle state,
compare the distance determined with reference values stored in a storage device,
determine at least one triggering size of the at least one airbag based on the comparison,
transmit triggering signals corresponding to the at least one triggering size to the at least one airbag,
define a first triggering size to activate the at least one airbag with a first deployment depth when the distance determined is below or corresponds to a first threshold value,
define a second triggering size to activate the at least one airbag with a second deployment depth when the distance determined is above the first threshold value, wherein the second deployment depth is larger than the first deployment depth, and
output a warning signal, which indicates an unsafe seat position of the vehicle occupant, via an output unit to the vehicle occupant when the distance determined is above a second threshold value which is greater than the first threshold value; and
at least one sensor system that continuously defines the head position of the vehicle occupant relative to a reference point in the vehicle and transmits the head position to the evaluation and control unit.

27. The restraint system of claim 26, wherein the at least one airbag comprises at least one tightening strap which limits deployment of the at least one airbag to a first deployment depth, and is released, by the evaluation and control unit, via a release element in order to activate the at least one airbag with the second deployment depth.

28. The restraint system of claim 26, further comprising:
at least one airbag generator actuated by the evaluation and control unit,
wherein the airbag generator sets an inflation speed of the at least one airbag depending on the distance determined, such that:
the airbag generator inflates the at least one airbag at a first speed if the distance determined is below or equal to a third threshold value, the third threshold value being smaller than the first threshold value, and
the airbag generator inflates the at least one airbag at a second speed if the distance determined is above the third threshold value, wherein the second speed is higher than the first speed.

29. The restraint system of 26, wherein the at least one airbag further comprises at least one valve, and
wherein the evaluation and control unit is further configured to define a triggering size of the at least one valve based on the comparison of the distance determined with stored reference values and to output a corresponding triggering signal to the at least one valve to adjust damping behavior of the at least one airbag.

30. The restraint system of 26, wherein the evaluation and control unit is further configured to change a position of a seat, before or when the restraint system is triggered, via at least one adjusting element in such a way that the distance between the head position of the vehicle occupant and the at least one airbag is in the range of the defined threshold values.

31. The restraint system of claim 26, wherein the at least one sensor system further comprises a distance sensor system which directly determines the head position of the vehicle occupant.

32. The restraint system of claim 26, wherein the at least one sensor system further comprises a seat position sensor system which indirectly determines the head position of the vehicle occupant.

33. The restraint system of claim 26, wherein the at least one sensor system further comprises a steering wheel sensor system which determines a current steering wheel position, and the steering wheel position is considered by the evaluation and control unit when determining the distance between the head position of a vehicle occupant and the at least one airbag in the idle state.

34. The restraint system of claim 26, further comprising a belt tensioner or an adaptive belt force limiter, and
wherein the evaluation and control unit is further configured to determine at least one triggering size of the belt tensioner or the adaptive belt force limiter based of the comparison of the distance determined with stored reference values and to transmit corresponding triggering signals to the belt tensioner or to the adaptive belt force limiter.
